(19) United States
(12) Patent Application Publication
(10) Pub. No.: US 2006/0291422 A1
(43) Pub. Date: Dec. 28, 2006

(54) Mobility management in a communication system of at least two communication networks

(75) Inventor: Timothy Rochford, San Diego, CA (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/448,761

(22) Filed: Jun. 8, 2006

Related U.S. Application Data
(60) Provisional application No. 60/693,794, filed on Jun. 27, 2005.

(51) Int. Cl. H04Q 7/00

(52) U.S. Cl. 370/331

(57) ABSTRACT

A method, network element, mobile node, system and computer program product for mobility management in a communication system comprising at least two communication networks, wherein a mobile node is associated with one of the at least two communication networks as a home network and is allocated a global home address, a certificate and a corresponding private key by a home agent of the home network, and wherein the mobile node, when roaming in a communication network other than the home network, requests a binding operation of a current routing address in the other communication network and the global home address at the home agent of the home network, comprising authenticating, at the home agent, the use of the correct allocated global home address by the mobile node by means of a digital signature and the certificate allocated to the mobile node.

This application claims benefit under 35 U.S.C. 119(e) of provisional application No. 60/693,794, filed on Jun. 27, 2005, the contents of which is incorporated by reference.

### FIELD OF THE INVENTION

The present invention relates to a method, network element, mobile node, system and computer program product for mobility management in a communication system comprising at least two communication networks.

### BACKGROUND OF THE INVENTION

In recent years, communication technology has widely spread in terms of number of users and amount of use of the telecommunication services by the users. This also led to an increase in the number of different technologies and technological concepts in use.

One trend in this regard is an integration of communication networks in overall communication systems. This concept is preferable in terms of ease and convenience of use as well as modularity regarding independence of development and operation of the single networks. Each network can e.g. be provided and operated by another individual operator. The thus integrated networks can be homogenous or even heterogeneous networks as regards the type and/or the underlying technology.

Another trend is the use of packet-switched communications which steadily replace circuit-switched communications, particularly in the field of data but also in the field of voice transmissions. This trend is at least partly based on the enormous increase of Internet usage and related applications over the last years.

Accordingly, also communication protocols used in the Internet have widely spread even in other fields of communication such as mobile communications. Therefore, Internet Protocol (IP) in general—and its versions v4 and v6 in particular—is the presumably most commonly used communication protocol in modern communication networks and systems. One example in this connection are mobile communication systems of phase 2+and the so-called third generation, such as General Packet Radio Service (GPRS), Code Division Multiple Access (CDMA) networks and Universal Mobile Telecommunication Systems (UMTS), for example.

However, the Internet Protocol is originally not adapted for the use in mobility-related environments, and thus has to be adapted accordingly in order to cope with the special requirements in such scenarios, such as e.g. routing, mobility management, and security. To this end, a derivative of the Internet Protocol is under development, which is specifically intended for mobile communication environments. This derivate is referred to as Mobile Internet Protocol with Mobile IPv6 being one example thereof.

Without Mobile IPv6, mobile nodes (MN) cannot use a single, fixed IPv6 address while they roam between different networks. Instead, each time a mobile node moves and changes network attachment points, it must manually re-configure a new IP address and a default router based on its current location, thereby temporarily losing its network connections and ability to communicate.

Mobile IPv6 is a protocol to allow a mobile device to be reachable and be able to use the same IPv6 global address regardless of the device's point of attachment to the communication system. With Mobile IPv6, a client IP node or mobile node (MN) can change network attachment points in the same or other networks and use a single, fixed IPv6 address regardless of its current attachment point. This global address is known as the mobile node's home address. The mobile node's home address is a unicast routable (global) address with the network prefix of the mobile node's home network. The Mobile Node's home network in turn is the network that administers the mobile node, i.e. the network to which the mobile node is associated from a management point of view, and is typically the network to which the Mobile Node is normally attached.

When a mobile node roams between networks, and thus is attached to a foreign network (i.e. a network other than its home network), it temporarily gets a current routing address, i.e. a so-called care-of address (COA) on the foreign network. The care-of address is an IPv6 unicast global address with the network prefix of the foreign network. The mobile node can get this address using IPv6 stateless auto-configuration, or by using a stateful configuration method (such as DHCP: Dynamic Host Configuration Protocol).

In the basic operation of Mobile IPv6, a so-called correspondent node (which is located in the same or another network as compared with the mobile node concerned) sends data packets to the mobile node using the mobile node's home address. A home agent (HA), i.e. a node or router on the mobile node's home network, intercepts these data packets and tunnels them to the mobile node's current care-of address. Accordingly, the mobile node sends data packets to a correspondent node via its home agent. For this purpose, the home agent of the mobile node always has to maintain updated mappings, so-called bindings, between the home address of the mobile node and its current COA (routing) address. Therefore, a roaming mobile node has to inform its home agent on its home network about his current care-of address.

In FIG. 1, there is shown a data transmission scenario in accordance with the basic operation described above. The mobile node concerned, denoted by MN, is located in a foreign network, i.e. in a communication network other than its home network. The respective home agent HA is located in the home network of the mobile node concerned, and a correspondent node CN is located in any network of the communication system. The double-headed arrows depict the path of packet data transmissions between the mobile node MN and the correspondent node CN. As can be gathered from FIG. 1, the data is in both directions routed via the home agent HA which maps the home address of the mobile node to its current care-of address in order to enable the routing of the data packets to and from the current location of the mobile node MN.

As should be clear from the above, a correct and reliable binding between home address and current care-of address of a mobile node is essential for a correct operation within the communication system comprising at least two networks.

If no authentication or security is used between the mobile node and the home agent, the following adverse effect is conceivable. A first mobile node establishes at some point in time a binding with its home address at the respective home agent. Then, a second mobile node will (e.g. as a result of an eavesdropping attack) be able to establish a binding with the same home address (of the first mobile node) at the same home agent. Even if the first mobile node has the right to use the respective home address, the home agent will effectively route packet data bound for the first mobile node to the second mobile node. This is due to the fact that the latest binding was established between the home address and the second mobile node and that this binding can not be detected as being erroneous or abusive.

In order to ensure the bindings to be trustworthy and correct, there are several approaches known in the art for providing authentication or security. As proposals to the Internet Engineering Task Force (IETF), there are for example known RFC3775 (“Mobility Support in Ipv6”) and RFC3776 (“Using IPSec to Protect Mobile IPv6 Signaling Between Mobile Nodes and Home Agents”). The Internet Draft entitled “Mobile IPv6 Operation with IKEv2 and the revised IPSec Architecture” by Vijay Devarapalli also addresses such issues. Further prior art approaches on how the home agent can authenticate the mobile node are presented in IETF'S working group directed to mobility for IPv6.

The known solutions are mainly based on the establishment of security associations and on shared secrets between the mobile node and the home agent. Namely, they rely on other protocols such as IPSec (Internet Protocol Security) in addition to the communication protocol used, such as e.g. IPv6 or Mobile IPv6. However, the use of a further protocol adds processing overhead, overall system complexity, and thus additional transmission delay. Alternatively or additionally, the above solutions rely on an existing AAA (authentication, authorization and accounting) infrastructure in the home network. Such an additional infrastructure would however demand for additional implementation efforts, and would add complexity and costs.

Providing authentication or security in the known manners still suffers from another drawback. That is, if the home prefix of the mobile node's home network is changed by the network administrator of the home network, the authentication or security data of the mobile node would have to be revoked. In this regard, for example any certificate or private key of the mobile note would have to be re-issued by the home network. Hence, deploying a known public key infrastructure and certificates as a mechanism for providing authentication or security is an expensive operation to undertake in terms of management efforts.

Thus, a solution to the above problems and drawbacks is needed for an efficient and reliable mobility management in a communication system of at least two communication networks.

### SUMMARY OF THE INVENTION

Consequently, it is an object of the present invention to remove the above drawbacks inherent to the prior art and to provide an accordingly improved method, network element, mobile node, system, and computer program product.

According to a first aspect of the invention, this object is for example achieved by a method for mobility management in a communication system comprising at least two communication networks, wherein a mobile node is associated with one of the at least two communication networks as a home network and is allocated a global home address, a certificate and a corresponding private key by a home agent of the home network, and wherein the mobile node, when roaming in a communication network other than the home network, requests a binding operation of a current routing address in the other communication network and the global home address at the home agent of the home network, the method comprising a step of authenticating, at the home agent, the use of a correct allocated global home address by the mobile node by means of a digital signature and the certificate allocated to the mobile node.

According to further advantageous developments one or more of the following applies:
the method further comprises a step of sending a binding message from the mobile node to the home agent for requesting the binding operation;
the method further comprising a step of receiving the binding message sent from the mobile node at the home agent;
the step of authenticating comprises a step of checking whether the digital signature in the binding message is correct for the requesting mobile node;
the step of checking further comprises the steps of computing a hash value of the received binding message; decrypting the digital signature in the binding message using the public key in the certificate allocated to the mobile node; and comparing the computed hash value and the decrypted digital signature;
the step of decrypting the digital signature further comprises the steps of looking-up the certificate allocated to the mobile node, which is stored at the home agent when being allocated to the mobile node, using the link-local address of the mobile node contained in the binding message; and retrieving the public key from the certificate allocated to the mobile node;
the use of the correct allocated global home address by the mobile node is authenticated, if it is detected in the comparing step that the private key corresponding to the certificate allocated to the mobile node has been used for encrypting the digital signature;
the certificate is a certificate according to X.509 specifications;
the communication system is operated based on an internet protocol; and/or
the communication system is operated based on a mobile internet protocol.

According to a second aspect of the invention, this object is for example achieved by a network element for mobility management in a communication system comprising at least two communication networks, wherein a mobile node is associated with one of the at least two communication networks as a home network and is allocated a global home address, a certificate and a corresponding private key by the network element acting as a home agent of the home network, and wherein the mobile node, when roaming in a communication network other than the home network, requests a binding operation of a current routing address in the other communication network and the global home address at the home agent of the home network, the network element comprising an authenticator configured to authenticate the use of the correct allocated global home address by the mobile node by means of a digital signature and the certificate allocated to the mobile node.

According to further advantageous developments one or more of the following applies:
the network element is configured to allocate a certificate including a link-local address of the global home address of the mobile node and a public key;
the network element further comprises a receiver configured to receive a binding message for requesting the binding operation, which is sent from the mobile node;
the authenticator is further configured to check whether the digital signature in the binding message is correct for the mobile node;
the authenticator comprises computing devices configured to compute a hash value of the received binding message; decrypting devices configured to decrypt the digital signature in the binding message using the public key in the certificate allocated to the mobile node; and a comparator configured to compare the hash value computed by the computing devices and the digital signature decrypted by the decrypting device;
the decrypting devices further comprise a database configured to store the certificate when being allocated to the mobile node; look-up devices configured to look-up the certificate allocated to the mobile node, which is stored in the database, using the link-local address of the mobile node contained in the binding message; and a retriever configured to retrieve the public key from the certificate allocated to the mobile node;
the authenticator is configured to authenticate the use of the correct allocated global home address by the mobile node, if it is detected by the comparator that the private key corresponding to the certificate allocated to the mobile node has been used for encrypting the digital signature;
the network element is operated based on an internet protocol; and/or
the network element is operated based on a mobile internet protocol.

According to a third aspect of the invention, this object is for example achieved by a mobile node in a communication system comprising at least two communication networks, wherein the mobile node is associated with one of the at least two communication networks as a home network and is allocated a global home address, a certificate and a corresponding private key by a home agent of the home network, the mobile node comprising a requester configured to request, when roaming in a communication network other than the home network, a binding operation of a current routing address in the other communication network and the global home address at the home agent of the home network, wherein the home agent authenticates use of the correct allocated global home address by the mobile node by means of a digital signature and the certificate allocated to the mobile node.

According to further advantageous developments one or more of the following applies:
the mobile node further comprises a sender configured to send a binding message to the home agent for requesting the binding operation;
the mobile node further comprises hashing devices configured to compute a hash value of the binding message; and encrypting devices configured to encrypt at least a part of the computed hash value of the binding message in a digital manner using the private key of the mobile node;
the mobile node is operated based on an internet protocol; and/or
the mobile node is operated based on a mobile internet protocol.

According to a fourth aspect of the invention, this object is for example achieved by a system for mobility management in a communication system comprising at least two communication networks, wherein a mobile node is associated with one of the at least two communication networks as a home network and is allocated a global home address, a certificate and a corresponding private key by a home agent of the home network, and wherein the mobile node, when roaming in a communication network other than the home network, requests a binding operation of a current routing address in the other communication network and the global home address at the home agent of the home network, the system comprising at least one of the network element according to the second aspect of the present invention, and at least one of the mobile node according to the third aspect of the present invention.

According to a fifth aspect of the invention, this object is for example achieved by a computer program product embodied on a computer-readable medium, the computer program being loadable into a memory of a digital processing means of a home agent and comprising software code portions for performing, when said product is run on said digital processing means, a method according to the first aspect of the present invention.

According to any one of the aspects of the present invention as described above:
the certificate includes a link-local address of the global home address allocated to the mobile node and a public key;
the binding message comprises the current routing address, the link-local address and the digital signature; and/or
the digital signature is an encrypted hash value of the binding message, wherein at least a part of the hash value is digitally encrypted using the private key of the mobile node.

It is an advantage of the present invention that the home agent can authenticate the mobile node in an improved manner. Stated in other words, the home agent can by means of the present mechanism advantageously verify that a mobile node is using the correct assigned home address.

Therewith, it is efficiently prevented that a mobile node claims the home address of another mobile node.

With the embodiments of the present invention, no security association and no shared secrets between the home agent and the mobile node are required. Further, it is advantageous that the present invention rather relies on public key cryptography and on digital signatures.

Advantageously, the present invention is also applicable to improve existing approaches and architectures.

### BRIEF DESCRIPTION OF THE DRAWINGS

In the following, the present invention will be described in greater detail with reference to the accompanying drawings, in which

FIG. 1 schematically shows a data transmission scenario between a mobile node in a foreign network and a correspondent node;

FIG. 2 shows a data format for a digital signature mobility option according to an embodiment of the present invention;

FIG. 3 shows a combined signaling and flow diagram of a method according to an embodiment of the present invention; and

FIG. 4 shows a block diagram of a mobile node and a home agent according to an embodiment of the present invention.

### DETAILED DESCRIPTION OF EMBODIMENTS OF THE PRESENT INVENTION

The present invention is described herein with reference to a particular non-limiting example. A person skilled in the art will appreciate that the invention is not limited to this or any other example, and may be more broadly applied.

In particular, the present invention is described in relation to an implementation scenario in accordance with Mobile Internet Protocol version 6, Mobile IPv6 in short. As such, the description of the embodiments given herein specifically refers to terminology which is directly related to Mobile IPv6. Such terminology is however only used in the context of the presented examples, and does not limit the invention in any way.

The present invention and the embodiments thereof can likewise be applied in an implementation scenario in accordance with any other communication protocol as long as this protocol provides for the same or similar features as Mobile IPv6, i.e. it is a mobility-adapted packet data protocol. The type of communication system and networks underlying the presented implementation scenario is not essential for the present invention as long as the communication system and networks are operable in accordance with Mobile IPv6 or any other comparable protocol. Conceivable networks in this regard are for example GPRS, UMTS, 3GPP, 3GPP2, CDMA, or X.25 networks.

The mechanism according to the present invention basically relies on the assumption that each mobile node is allocated a certificate and a private key corresponding thereto, which are generated at the home network of the respective mobile node (for example at a home agent thereof). The home network, or the home agent of the home network, also generates and allocates the home address of each mobile node being associated with this network, thus being called the home network of the mobile node. For the below description, the home address is to be understood as a global IPv6 address.

For the sake of completeness, it is to be noted that a home network could also be able to delegate the issuing and maintenance of certificates to a third party. For example, there are service providers specialized for such tasks, to which network operators and companies can delegate the allocation and administration of PKI issues.

Generally, the allocated certificate can for example be a certificate according to a public key infrastructure (PKI). According to an embodiment of the present invention, the certificate allocated to mobile nodes is a certificate in accordance with ITU (International Telecommunications Union) Recommendation X.509, and more particularly in accordance with version 3 thereof, i.e. a X509v3 certificate.

As commonly used, the term “certificate” is herein below to be understood as a digital document attesting to the binding of a public key (included in the certificate) to an individual or other entity. It allows verification of the entitlement that a given public key does in fact belong to a given individual, for example a mobile node or a user thereof. Certificates thus help to prevent someone from using a phony key to impersonate someone else.

In their simplest form, certificates contain a public key and a name. According to an embodiment of the present invention, the allocated X509v3 certificate includes as the name an IPv6 link-local address that the mobile node is assigned. More precisely, it is a link-local version of the global home address of the mobile node, and thus is formulated from the IPv6 global home address that the home agent assigned for the respective mobile node.

In contrast to global addresses having the scope of the entire communication system and site-local addresses having the scope of an entire site (or organization), a link-local addresses generally has a smaller scope. Namely, it refers only to a particular physical link (physical network) within the communication system. Thus, routers will not forward datagrams using link-local addresses at all, not even within the site or organization; they are only for local communication on a particular physical network segment. As is well known, link-local addresses are differentiated from site-local addresses by having a tenth bit of “0” following the nine initial address bits common to all private IPv6 addresses. Thus, in binary form, link-local addresses begin with the bit sequence “1111 1110 10” followed by 54 zeros and 64 bits of an interface identifier which is derived from e.g. a MAC (medium access control) address of the respective mobile node.

The association of the IPv6 link-local home address of a mobile node in its allocated certificate has the effect that the information contained in the certificate is still correct, even if the home prefix of the mobile node's home network changes. This is advantageous as compared with the prior art as described above, where exemplarily the IPv6 global address would be used in the certificate resulting in that the address would have an incorrect prefix portion if the home network is renumbered.

According to an embodiment of the present invention, the certificate allocated to a mobile node is flashed, i.e. transferred, on to the mobile node along with the corresponding private key. Alternatively, the mobile node downloads the certificate and the corresponding private key from a certificate authority of the home agent at any point using for example a web browser, for example when the mobile node wishes to use a functionality of Mobile IPv6 for which such a certificate is required. As a further alternative, the mobile node uses a protocol such as SCEP (“Simple Certificate Enrollment Protocol”) or the like in order to generate the certificate (and the corresponding private key) by itself.

A copy of the certificates allocated to each respective mobile node is also kept by the home agent (or the home network). The home agent (or the home network) does however not know the private key allocated to each respective mobile node, and the mobile nodes each have to keep their private key confidential.

In short, there is provided a concept of mobility management in a communication system comprising at least two communication networks, wherein a mobile node is associated with one of the at least two communication networks as a home network and is allocated a global home address, a certificate and a corresponding private key by a home agent of the home network, and wherein the mobile node, when roaming in a communication network other than the home network, requests a binding operation of a current routing address in the other communication network and the global home address at the home agent of the home network, the concept comprising a step of authenticating, at the home agent, the use of the correct allocated global home address by the mobile node by means of a digital signature and the certificate allocated to the mobile node.

According to an embodiment of the present invention, a new mobility option is defined in the framework of RFC3775 (see above). In RFC3775, a mobility message can include one or more so-called mobility options. The new mobility option according to the present embodiment is a digital signature mobility option and is included in binding messages (including binding update messages). In the context of the present invention, such binding messages are messages sent from a mobile node to its home agent when the mobile node roams in a foreign network and attaches to a router therein. The binding messages are for requesting a binding operation of a current (routing) address in the foreign network and the global home address of the mobile node at the home agent of the home network.

The digital signature mobility option according to the present embodiment includes a hash value of the binding message as such, wherein the hash value is digitally encrypted by the mobile node using its private key.

The hash value is for example calculated in accordance with version 1 of the Secure Hash Algorithm (SHA), i.e. SHA1. According to the presented embodiment, the calculated hash value is truncated so that only for example the first 128 bits of the 160 bits of the resulting hash value remain to be used for being encrypted by means of SHA1. In the below equations, this is represented by the syntax “First(128,SHA1(Data))”. In short, the digital signature mobility option is defined as follows:
DigitalSig. =Private_Key_Encrypt(First(128, SHA1(Data))
Data =care-of address|correspondent|MH Data,
wherein “|” denotes a concatenation of the elements to the left and to the right of the symbol “|” . Care-of address denotes the current (routing) address of the mobile node in the foreign network, i.e. the COA address which will be registered for the mobile node at the home agent when the binding operation succeeds. Alternatively, it is the home address of the mobile node if this option is used in de-registration. It is to be noted that the care-of address might be different from the source address of the binding message including the respective digital signature. This is the case if the alternative care-of address mobility option is used, or when the lifetime of the binding is set to zero.

The element denoted as “correspondent” represents the address (e.g. IPv6 address) of the correspondent node (i.e. the router in the foreign network) or the home agent. It is to be noted that, if the binding message is sent to a destination address which itself is mobile, the “correspondent” address may not be the address found in the destination address field of an IPv6 header; rather, the home address from the type 2 routing header should be used.

The “MH Data” is the content of the mobility header according to Mobile IPv6, excluding the digital signature field itself. It could contain the global home address of the mobile node originating the binding message. The digital signature value is calculated as if the checksum field in the mobility header was zero. The checksum in a transmitted packet is calculated in the usual and well known manner with the calculated digital signature being a part of the packet which is protected by the checksum.

Accordingly, the “Data” on which the SHA1 operation is carried put represents the binding message as such.

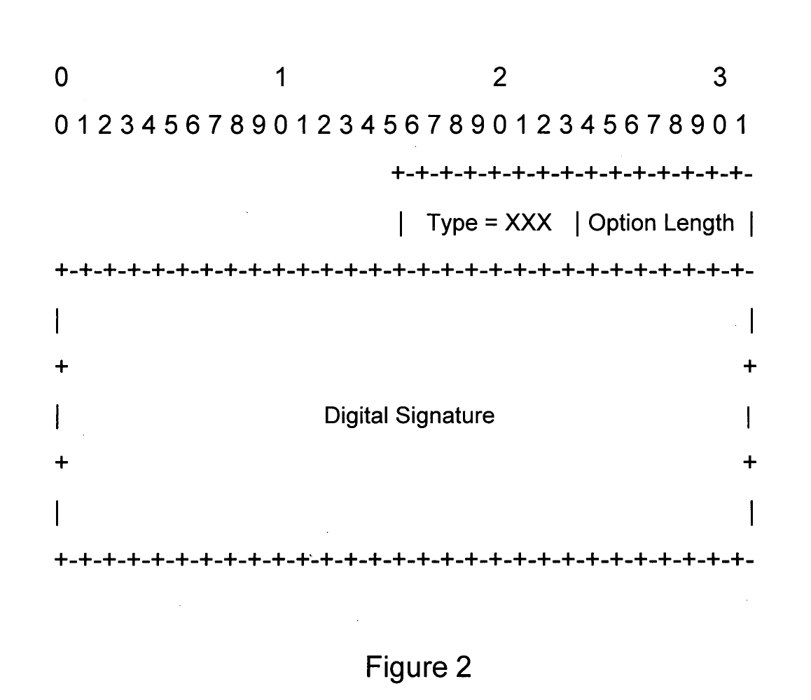

FIG. 2 shows a data format for a digital signature mobility option according to an embodiment of the present invention. In FIG. 2, the “+” and “−” symbols represent border lines between the individual fields in the mobility option format structure, and the numbering at the top refers to respective bit positions.

The basic structure of the option format is in accordance with a mobility option pursuant to RFC3775. The type is denoted by XXX representing a place holder, wherein the actual value of the type could be any type identifier which will be assigned to the digital signature mobility option in the future, for example by a standards body such as IANA (“Internet Assigned Numbers Authority”). The option length is naturally variable depending on the length of the digital signature calculated, which in turn is illustrated as the payload.

The home agent receives the binding (update) message sent from the mobile node roaming in a foreign network and is able to check (and actually checks) that the digital signature in the message is correct for the requesting mobile node. That is, the home agent authenticates the use of the correct allocated global home address by the mobile node by means of the digital signature received and the certificate allocated to the mobile node.

For checking this, the home agent computes a hash value of the binding message as such using the same hash algorithm as the mobile node, e.g. SHA1. Then, the home agent decrypts the hash value in the message (which has been digitally encrypted using the mobile node's private key). That is, the home agent decrypts the digital signature received. For this purpose, the home agent uses the link-local address of the mobile node's home address (which is contained in the received binding message) to look-up the correct certificate of the mobile node which is stored at the home agent when allocating it to the mobile node. From the certificate, the public key of the mobile node is retrieved, which is then used to decrypt the digital signature received.

More specifically, the home address option field of the IPv6 destination options extension header in the IP packet containing the binding (update) message includes the home address of the mobile node from which the binding (update) message originates. As stated above, this home address is exemplarily a global IPv6 home address. Upon receipt of the IP packet containing the binding (update) message, the home agent HA retrieves the global home address from the above mentioned header and derives the link-local version thereof. The home agent then searches a database using the link-local address as a look-up. In detail, the home agent searches for that the subject alternative name field of the X509v3 certificate matches the IPv6 link-local address used as a look-up.

Subsequently, the computed hash value of the message is compared with the decrypted digital signature by the home agent. The use of the correct allocated global home address by the mobile node is authenticated, if it is detected by the comparison that the private key corresponding to the certificate allocated to the mobile node has been used for encrypting the digital signature. If the authentication fails, the home agent knows that the mobile node does not possess the correct private key associated with the certificate that contains the link-local version of the respective home address.

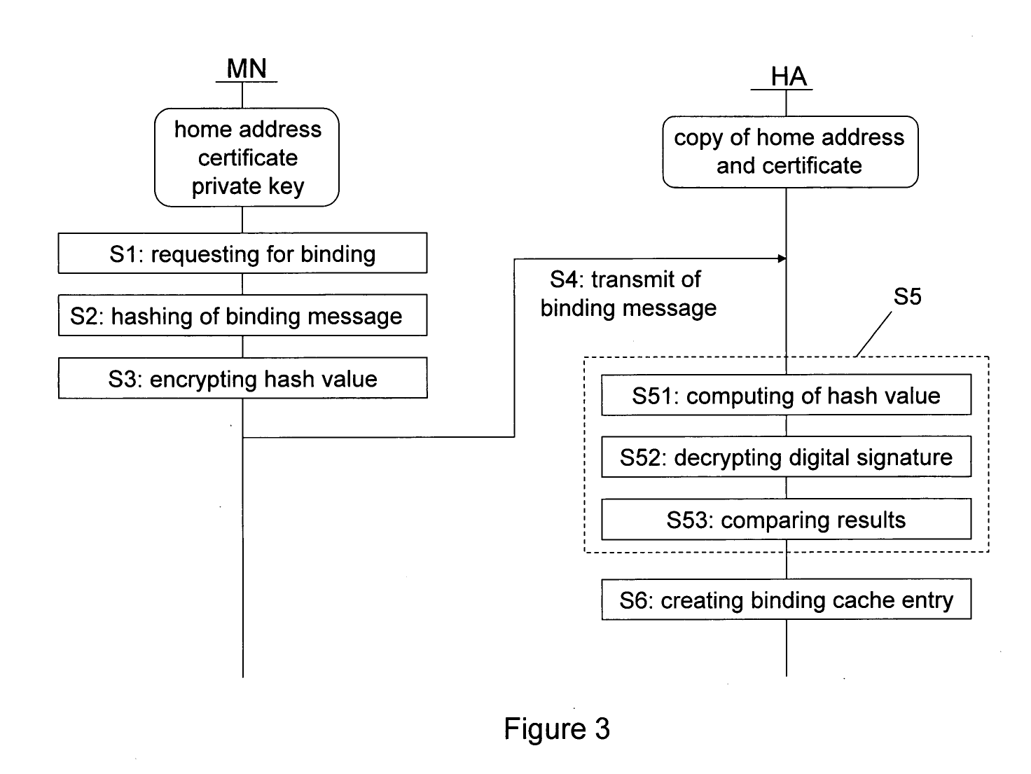

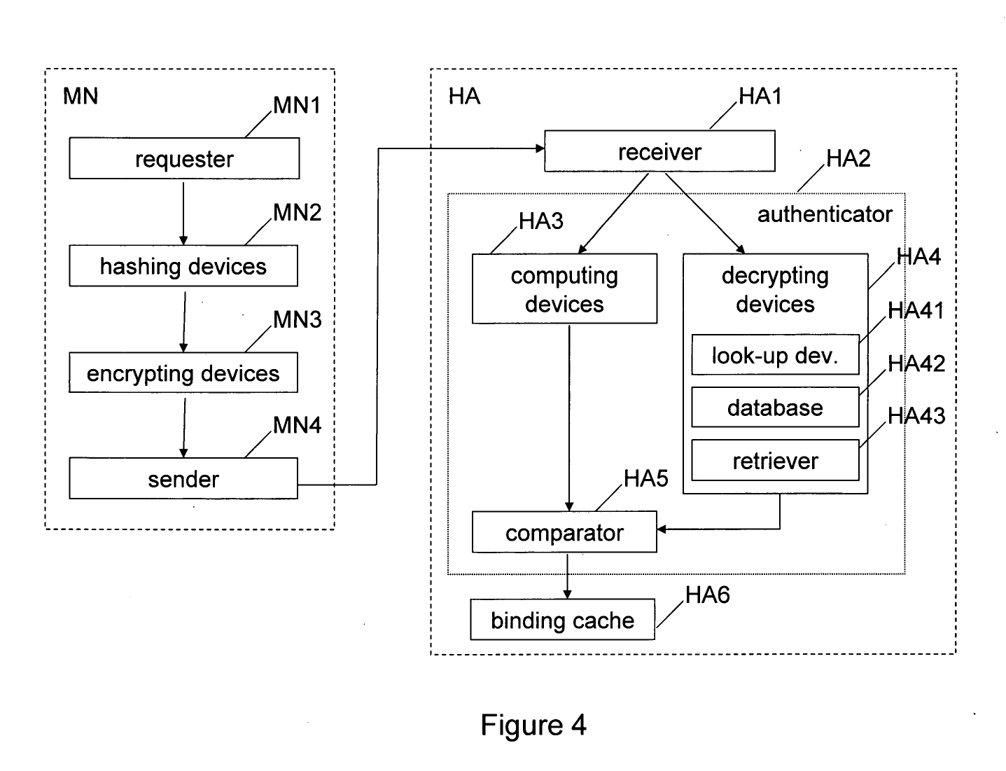

In the following, there will be described some specific embodiments of the present invention by way of example with reference to FIGS. 3 and 4. It is to be noted that the present invention is not restricted to the arrangements as illustrated and described below. Rather, some steps or constituent parts can be left out and/or others can be added without departing from the present invention as long as the basic principles of the present invention as set out above are realized.

FIG. 3 shows a combined signaling and flow diagram of a method according to an embodiment of the present invention.

In FIG. 3, the mobile node denoted by MN is assumed to be roaming in a foreign network, i.e. a network of the communication system other than its home network in which the home agent HA is located. The mobile node already has been allocated a home address, a certificate comprising a link-local version of its home address and a public key, and a private key. These data have been generated by the mobile node's home agent HA, where a copy of the home address and the certificate are maintained.

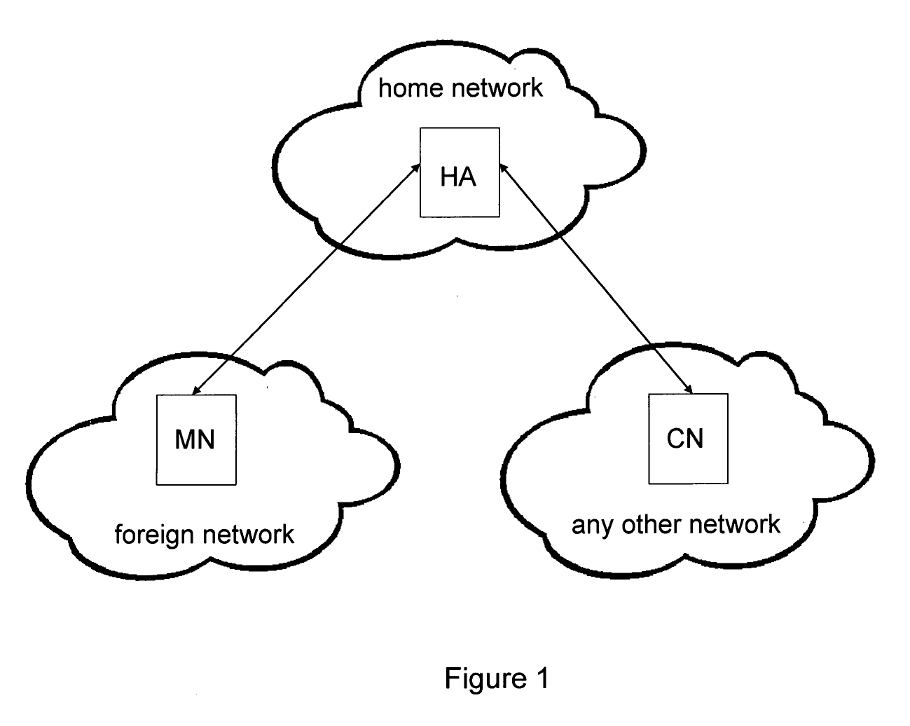

As the roaming mobile node connects to a router in the foreign network, it is also allocated a current routing address in this network, which is also referred to as care-of address COA. For ensuring a correct routing of data packets to and from the mobile node (cf. FIG. 1) it is essential that the home agent always keeps a correct binding information, i.e. a binding cache entry, for mapping the care-of address and the home address of the mobile node.

In step S1 of FIG. 3, the mobile node requests a respective binding operation to be performed at the home agent. To this effect, a corresponding binding message is generated at the mobile node. For enabling the home agent to authenticate the mobile node and its use of the correct allocated home address, steps S2 and S3 are carried out by the mobile node. In step S2, the mobile node hashes the generated binding message, i.e. it calculates a hash value of the message. This is done using a hash algorithm such as SHA1. In step S3, the mobile node then encrypts the hash value of the binding message using its private key. The encrypted hash value of the binding message is added to the binding message as such as a digital signature of the mobile node.

Then, in step S4, the binding message including the digital signature is transmitted from the mobile node MN to the home agent HA.

At the home agent HA, the use of the correct allocated global home address by the mobile node is authenticated by means of the digital signature and the certificate allocated to the mobile node. This is effected in step S5 by checking whether the digital signature in the binding message is correct for the requesting mobile node MN. In detail, a hash value of the received binding message is computed (step S51), the digital signature is (after being extracted from the received binding message) decrypted (step S52), and the computed hash value is compared with the decrypted digital signature (step S53).

For decrypting the digital signature, the home agent HA looks up the certificate allocated to the requesting mobile node MN in a database, in which the certificate of the mobile nodes is stored when being allocated. For this purpose, the link-local address of the mobile node contained in the binding message is used. Then, the public key is retrieved from the certificate allocated to the requesting mobile node and used for the respective decrypting operation.

Finally, the use of the correct allocated global home address by the mobile node is authenticated by the home agent HA, if it is detected by the comparison that the private key corresponding to the certificate allocated to the mobile node has been used for encrypting the digital signature. In this case, the home agent HA in step S6 creates a corresponding binding cache entry in its binding cache. Otherwise, such a binding cache entry is denied, and alternatively other actions can also be taken, such as for example notifying another entity of an attempted abuse of a home address by a mobile node.

According to a further embodiment of the present invention, the method according to any embodiment can be implemented by a computer program product being loadable into a memory of a digital processing means, which in the described case is arranged at a home agent network element.

FIG. 4 shows a block diagram of a mobile node and a home agent according to an embodiment of the present invention. Thereby, also an embodiment of a system according to the present invention is shown although such a system can as well comprise more than one mobile node and more than one home agent. The arrows in FIG. 4 illustrate both the physical and/or logical connections between the individual blocks and the flow of operation.

The mobile node MN according to the embodiment of FIG. 4 comprises a requester MN1 which is configured to request, when the mobile node MN is roaming in a foreign network other than the home network, a binding operation of a current routing address in the foreign network and the global home address of the mobile node. Such a binding operation is requested to be performed at the home agent of the home network. For this purpose, a respective binding message is generated by the requester, the details of which binding message being described above.

In a hashing device MN2 of the mobile node MN, there is computed a hash value of the binding message generated at and obtained from the requester MN1. In encrypting devices MN3 of the mobile node MN, the hash value computed in the hashing devices MN2 is encrypted in a digital manner using the private key of the mobile node MN. The binding message as well as the computed and encrypted hash value thereof (i.e. the digital signature of the mobile node MN) are transferred to a sender MN4 of the mobile node MN. The sender MN4 sends the binding message including the digital signature to the home agent HA. Thereby, the required binding operation is requested to be performed at the home agent HA.

Accordingly, the binding message to be sent by the sender MN4 comprises the current routing address, the link-local address and the digital signature of the mobile node MN, wherein the digital signature is an encrypted hash value of the binding message as such, and the hash value is digitally encrypted using the private key of the mobile node.

The home agent HA according to the embodiment of FIG. 4 comprises a receiver HA1 for receiving the binding message from the mobile node MN or the sender MN4 thereof. The home agent HA of the present embodiment further comprises an authenticator HA2 which operates for authenticating the use of the correct allocated global home address by the mobile node MN from which the current binding message has been received. The authenticator HA2 is configured to effect the authentication by means of the digital signature in the received binding message and the certificate allocated to the mobile node MN. Stated in other words, the authenticator is for checking whether the digital signature in the received binding message is correct for the requesting mobile node MN. Accordingly, the operation of the authenticator HA2 can be understood as an authenticating and/or an checking operation

According to FIG. 4, the authenticator HA2 comprises computing devices HA3, decrypting devices HA4 and a comparator HA5.

The computing devices HA3 compute a hash value of the received binding message obtained from the receiver HA1. The decrypting devices HA4 decrypt the digital signature in the binding message, which previously has to be extracted therefrom, using the public key of the certificate allocated to the mobile node. In the embodiment shown in FIG. 4, the decrypting devices HA4 comprise a database HA42, in which the certificate is stored when being allocated to the mobile node MN, look-up devices HA41 for looking-up the certificate allocated to the requesting mobile node MN, which is stored in the database HA42, using the link-local address of the mobile node MN contained in the binding message, and a retriever HA43 for retrieving the public key from the certificate allocated to the requesting mobile node MN and looked-up in the database HA42 by the look-up devices HA41. The database HA42 is for example a LDAP database (LDAP: lightweight directory access protocol). The comparator HA5 is supplied with the hash value computed by the computing devices HA3 and the digital signature decrypted by the decrypting devices HA4. The comparator HA5 then compares the supplied hash value and digital signature in order to obtain a result of the authentication of the mobile node MN.

The mobile node MN, and thus the use of the correct allocated global home address by the mobile node, is assumed to be authenticated by the home agent HA or the authenticator HA2 thereof, if it is detected by the comparator that the private key corresponding to the certificate of the requesting mobile node MN has been used for encrypting the digital signature. In this case, the home agent performs the requested binding operation. That is, the home agent creates a respective binding cache entry in its binding cache HA6, which maps the global home address of the mobile node MN to its current routing (COA) address of the foreign network in which the mobile node MN currently roams.

The mobile node MN and the network element (i.e. home agent HA) illustrated in FIG. 4 (and thus the system comprised thereof) are thus configured for use in a method for mobility management as defined in the appended claims.

In general, it is to be noted that the mentioned functional elements, e.g. the requester or the authenticator according to the present invention, and their constituents can be implemented by any known means, either in hardware and/or software, respectively, if it is only adapted to perform the described functions of the respective parts. For example, the authenticator of the network element (or home agent) can be implemented by any data processing unit, e.g. a microprocessor, being configured to authenticate the use of the correct allocated global home address by the mobile node by means of a digital signature and the certificate allocated to the mobile node as defined by the appended claims. The mentioned parts can also be realized in individual functional blocks or by individual devices, or one or more of the mentioned parts can be realized in a single functional block or by a single device. Correspondingly, the above illustration of FIG. 4 is only for illustrative purposes and does not restrict an implementation of the present invention in any way.

Furthermore, method steps likely to be implemented as software code portions and being run using a processor at one of the peer entities are software code independent and can be specified using any known or future developed programming language such as e.g. C, C++, and Assembler. Method steps and/or devices or means likely to be implemented as hardware components at one of the peer entities are hardware independent and can be implemented using any known or future developed hardware technology or any hybrids of these, such as MOS, CMOS, BiCMOS, ECL, TTL, etc, using for example ASIC components or DSP components, as an example. Generally, any method step is suitable to be implemented as software or by hardware without changing the idea of the present invention. Devices and means can be implemented as individual devices, but this does not exclude that they are implemented in a distributed fashion throughout the system, as long as the functionality of the device is preserved. Such and similar principles are to be considered as known to those skilled in the art.

By means of the above, there is presented a mechanism by which the home agent can be assured that the mobile node has requested a binding of the correct home address before creating a binding cache entry at the home agent. This approach relies on the certificate and private key to authenticate the mobile node. It does neither require IPSec or any other further (security) protocol nor that the home network has AAA infrastructure. Encrypting the hash of the binding message (according to an embodiment of the present invention) is less resource intensive than using e.g. ESP operation of IPSec (ESP: encapsulating security payload) to encrypt the whole binding message. The only requirement is that the home network is able to issue certificates to mobile nodes and that the home agent (or home network) stores a copy of the certificates issued. The home agent must also be able to look-up the public key based upon the IPv6 link-local address contained in the certificate. This is overall advantageous as compared with known approaches.

It is further to be noted that the binding message and its contents can be authenticated by means of the present invention, but confidentiality is not provided. Also, only the mobile node is authenticated, not the home agent.

Based upon the principles of the present invention, further current development issues can be addressed. For example, as each mobile node will have a unique pair of private key and certificate (i.e. public key), this approach is suited to assist in solving the bootstrapping problem known in the art. If for example a fully qualified domain name (FQDN) such as for example “ha.nokia.com” was also included in the certificate allocated to a mobile node, the mobile node would be able to perform a domain name server (DNS) look-up for the address, and would be able to be informed of the current home network prefix (i.e. dynamic home agent address discovery (DHAAD) anycast address) or be given a home agent address.

According to the present invention, there is provided a method, network element, mobile node, system and computer program product for mobility management in a communication system comprising at least two communication networks, wherein a mobile node is associated with one of the at least two communication networks as a home network and is allocated a global home address, a certificate and a corresponding private key by a home agent of the home network, and wherein the mobile node, when roaming in a communication network other than the home network, requests a binding operation of a current routing address in the other communication network and the global home address at the home agent of the home network, comprising authenticating, at the home agent, the use of the correct allocated global home address by the mobile node by means of a digital signature and the certificate allocated to the mobile node.

Even though the invention is described above with reference to the examples according to the accompanying drawings, it is clear that the invention is not restricted thereto. Rather, it is apparent to those skilled in the art that the present invention can be modified in many ways without departing from the scope of the inventive idea as disclosed in the appended claims.

1. A method for mobility management in a communication system comprising at least two communication networks, wherein a mobile node is associated with one of the at least two communication networks as a home network and is allocated a global home address, a certificate and a corresponding private key by a home agent of the home network, and wherein the mobile node, when roaming in a communication network other than the home network, requests a binding operation of a current routing address in the other communication network and the global home address at the home agent of the home network, the method comprising a step of:
authenticating, at the home agent, the use of a correct allocated global home address by the mobile node by means of a digital signature and a certificate allocated to the mobile node.

2. The method according to claim 1, wherein the certificate includes a link-local address of the global home address allocated to the mobile node and a public key.

3. The method according to claim 2, wherein the method further comprises a step of:
sending a binding message from the mobile node to the home agent for requesting the binding operation, wherein the binding message comprises a current routing address, the link-local address and the digital signature.

4. The method according to claim 3, wherein the digital signature is an encrypted hash value of the binding message, wherein at least a part of the hash value is digitally encrypted using the private key of the mobile node.

5. The method according to claim 3, the method further comprising a step of:
receiving the binding message sent from the mobile node at the home agent.

6. The method according to claim 5, wherein the step of authenticating comprises a step of:
checking whether the digital signature in the binding message is correct for the requesting mobile node.

7. The method according to claim 6, wherein the step of checking further comprises the steps of:
computing a hash value of the received binding message;
decrypting the digital signature in the binding message using the public key in the certificate allocated to the mobile node; and
comparing the computed hash value and the decrypted digital signature.

8. The method according to claim 7, wherein the step of decrypting the digital signature further comprises the steps of:
looking-up the certificate allocated to the mobile node, which is stored at the home agent when being allocated to the mobile node, using the link-local address of the mobile node contained in the binding message; and
retrieving the public key from the certificate allocated to the mobile node.

9. The method according to claim 7, wherein the use of the correct allocated global home address by the mobile node is authenticated, if it is detected in the comparing step that the private key corresponding to the certificate allocated to the mobile node has been used for encrypting the digital signature.

10. The method according to claim 1, wherein the certificate is a certificate according to X.509 specifications.

11. The method according to claim 1, wherein the communication system is operated based on an internet protocol.

12. The method according to claim 1, wherein the communication system is operated based on a mobile internet protocol.

13. A network element for mobility management in a communication system comprising at least two communication networks, wherein a mobile node is associated with one of the at least two communication networks as a home network and is allocated a global home address, a certificate and a corresponding private key by the network element acting as a home agent of the home network, and wherein the mobile node, when roaming in a communication network other than the home network, requests a binding operation of a current routing address in the other communication network and the global home address at the home agent of the home network, the network element comprising:
an authenticator configured to authenticate use of a correct allocated global home address by the mobile node by means of a digital signature and the certificate allocated to the mobile node.

14. The network element according to claim 13, wherein the network element is configured to allocate a certificate including a link-local address of the global home address of the mobile node and a public key.

15. The network element according to claim 14, further comprising:
a receiver configured to receive a binding message for requesting the binding operation, which is sent from the mobile node.

16. The network element according to claim 15, wherein the binding message comprises a current routing address, the link-local address and the digital signature.

17. The network element according to claim 16, wherein the digital signature is an encrypted hash value of the binding message, wherein at least a part of the hash value is digitally encrypted using the private key of the mobile node.

18. The network element according to claim 17, wherein the authenticator is further configured to check whether the digital signature in the binding message is correct for the mobile node.

19. The network element according to claim 18, wherein the authenticator comprises:
computing devices configured to compute a hash value of the received binding message;
decrypting devices configured to decrypt the digital signature in the binding message using the public key in the certificate allocated to the mobile node; and
a comparator configured to compare the hash value computed by the computing devices and the digital signature decrypted by the decrypting devices.

20. The network element according to claim 19, wherein the decrypting devices further comprise:
a database configured to store the certificate when being allocated to the mobile node;
look-up devices configured to look-up the certificate allocated to the mobile node, wherein the certificate is stored in the database, using the link-local address of the mobile node contained in the binding message; and
a retriever configured to retrieve the public key from the certificate allocated to the mobile node.

21. The network element according to claim 20, wherein the authenticator is configured to authenticate use of the correct allocated global home address by the mobile node, if it is detected by the comparator that the private key corresponding to the certificate allocated to the mobile node has been used for encrypting the digital signature.

22. The network element according to claim 13, wherein the network element is operated based on an internet protocol.

23. The network element according to claim 13, wherein the network element is operated based on a mobile internet protocol.

24. A mobile node in a communication system comprising at least two communication networks, wherein the mobile node is associated with one of the at least two communication networks as a home network and is allocated a global home address, a certificate and a corresponding private key by a home agent of the home network, the mobile node comprising:
a requester configured to request, when roaming in a communication network other than the home network, a binding operation of a current routing address in the other communication network and the global home address at the home agent of the home network, wherein
the home agent authenticates use of the correct allocated global home address by the mobile node by means of a digital signature and the certificate allocated to the mobile node.

25. The mobile node according to claim 24, wherein the certificate includes a link-local address of the global home address allocated to the mobile node and a public key.

26. The mobile node according to claim 25, further comprising:
a sender configured to send a binding message to the home agent for requesting the binding operation, wherein the binding message comprises the current routing address, the link-local address and the digital signature.

27. The mobile node according to claim 26, wherein the digital signature is an encrypted hash value of the binding message, wherein at least a part of the hash value is digitally encrypted using the private key of the mobile node.

28. The mobile node according to claim 27, further comprising:
hashing devices configured to compute a hash value of the binding message; and
encrypting devices configured to encrypt at least a part of the computed hash value of the binding message in a digital manner using the private key of the mobile node.

29. The mobile node according to claim 24, wherein the mobile node is operated based on an internet protocol.

30. The mobile node according to claim 24, wherein the mobile node is operated based on a mobile internet protocol.

31. A system for mobility management in a communication system comprising at least two communication networks, wherein a mobile node is associated with one of the at least two communication networks as a home network and is allocated a global home address, a certificate and a corresponding private key by a home agent of the home network, and wherein the mobile node, when roaming in a communication network other than the home network, requests a binding operation of a current routing address in the other communication network and the global home address at the home agent of the home network, the system comprising:
at least one of the network element, the network element comprising:
an authenticator configured to authenticate the use of the correct allocated global home address by the mobile node by means of a digital signature and the certificate allocated to the mobile node, and
at least one of the mobile node, the mobile node comprising:
a requester configured to request, when roaming in a communication network other than the home network, a binding operation of a current routing address in the other communication network and the global home address at the home agent of the home network.

32. The system according to claim 31, wherein the certificate includes a link-local address of the global home address allocated to the mobile node and a public key.

33. A computer program embodied on computer-readable medium, the computer program being loadable into a memory of a digital processing means of a home agent and comprising software code portions for performing, when said product is run on said digital processing means, a step of:
authenticating the use of the correct allocated global home address by a mobile node by means of a digital signature and a certificate allocated to the mobile node.

34. The computer program according to claim 33, wherein the certificate includes a link-local address of the global home address allocated to the mobile node and a public key.
